(19) United States
(12) Patent Application Publication
(10) Pub. No.: US 2026/0221054 A1
(43) Pub. Date: Jul. 30, 2026

(54) Simulated Joint Modular Articular Components

(71) Applicant: Howmedica Osteonics Corp., Mahwah, NJ (US)

(72) Inventors: Scott G. Logan, Oak Ridge, NJ (US); Seth Jerabek, Pelham, NY (US)

(21) Appl. No.: 19/040,989

(22) Filed: Jan. 30, 2025

Related U.S. Application Data
(60) Provisional application No. 63/553,687, filed on Feb. 15, 2024.

(51) Int. Cl. G09B 23/32; G09B 23/34

(52) U.S. Cl. CPC G09B 23/32; G09B 23/34

(57) ABSTRACT

A joint simulator for simulating biomechanical properties of a joint includes a first end simulating a first bone of the joint, a second end simulating a second bone of the joint, at least one flexible band simulating a ligament of the joint, a first surface component connected to the first end, and a second surface component connected to the second end. The flexible band couples the first and second ends and is adjustable to simulate stresses corresponding to the first and second ends. The first surface component simulates a distal end of the first bone and the second surface component simulates a proximal end of the second bone.

### CROSS-REFERENCE TO RELATED APPLICATION(S)

This application claims the benefit of the filing date of U.S. Provisional Ser. No. 63/553,687 filed Feb. 15, 2024, the disclosure of which is hereby incorporated herein by reference.

### BACKGROUND OF THE INVENTION

Medical training and education frequently include the observation of bone shapes and articulation of joints outside of a live patient. Simple artificial bone models, such as sawbones, may be used for this purpose. Such artificial bone models are commonly constructed according to typical dimensions and features for a given population. The artificial bone models may be assembled to demonstrate how the bones would articulate at certain joints in a live patient and to allow for simulated surgical procedures to be performed on such bones. The lack of realistic ligaments and unique individual features limits the verisimilitude of joints simulated by artificial bone assemblies. The utility of known bone models is further limited with regard to representation of injuries and deformities, which are frequently atypical by nature and therefore difficult to generalize.

Cadaveric joints may also be observed for training purposes. Cadaveric joints provide some pedagogical advantages over artificial bone models including the presence of soft tissue and unique individual features and deformities. However, it can be difficult or impossible to determine the cause of deformities in cadaveric bones or the impact that such deformities have on quality of life. Moreover, cadavers present with their own unique deformities and ligament structure which may not coincide with classroom instruction dedicated to well defined scenarios a surgeon may face in practice. In this regard, cadavers lack the reproducibility that is helpful in allowing surgeons to troubleshoot particular scenarios to optimize results, as it is impossible to compare a difference in outcomes between two different interventions on a single unique cadaveric joint. Also, cadavers are relatively expensive, in less supply than artificial models, and require special facilities and handling to prevent the spread of infectious diseases that may persist after death. Thus, cadavers may have little value where a surgeon is preparing for a particular patient's anatomy in accordance with their preoperative routine or as part of a particular training regimen.

The training value in both simulated and cadaveric joints is further limited by the amount of information that a student or clinician can derive from merely observing or manipulating a joint. Visual and tactile information presented from a joint only enables the student or clinician to estimate stresses resulting from deformities or interventions, which can impede both the determination of the proper intervention for a given deformity and the assessment of an intervention after it has been enacted.

### BRIEF SUMMARY OF THE INVENTION

In one embodiment of a first aspect of the present disclosure, a joint simulator is used for simulating biomechanical properties of a joint. The joint simulator includes a first end simulating a first bone of the joint, a second end simulating a second bone of the joint, at least one flexible band simulating a ligament of the joint, and a first and second surface component. The flexible band couples the first and second ends and is adjustable to simulate stresses corresponding to the first and second ends. The first surface component is connected to the first end, and the second surface component is connected to the second end. The first surface component simulates a distal end of the first bone and the second surface component simulates a proximal end of the second bone.

In another embodiment of the first aspect, the first and second ends are separated by an opening of the joint simulator. Further, the first end is proximate to the second end. In yet another embodiment of the first aspect, the first and second surface components are comprised of a solid composition and provide for a fixed representation of a bone anatomy. In yet another embodiment of the first aspect, the first and second surface components are comprised of a two-part polymer filled composition and provide for a representation of cortical or cancellous bone. In yet another embodiment of the first aspect, the first and second surface components are patient specific. In yet another embodiment of the first aspect, the first and second surface components are for a single use and are disposable. In yet another embodiment of the first aspect, the first bone is a femur and the second bone is a tibia. Further, the first surface component is a tibia counter surface assembly, and the second surface component is a femoral counter surface assembly. In yet another embodiment of the first aspect, the first and second surface components are native diseased anatomy counter surfaces.

In one embodiment of a second aspect of the present disclosure, a simulated joint comprises a first articular surface component, a second articular surface component, and at least one flexible band. The first articular surface component is connected to a first end simulating a first bone of the simulated joint. The second articular surface component is connected to a second simulating a second bone of the simulated joint. Portions of the first and second articular surface components are configured to be resected during a simulated surgical procedure. The at least one flexible band is simulating a ligament of the simulated joint. The flexible band is coupling the first and second ends such that the first articular surface is proximate to the second articular surface.

In another embodiment of the second aspect, the first articular surface component is a tibia counter surface assembly, and the second articular surface component is a femoral counter surface assembly. Further, the simulated surgical procedure is a total knee arthroplasty. In yet another embodiment of the second aspect, the first and second articular surface components are configured to be removed after the simulated surgical procedure. Further, the first and second articular surface components are configured to be replaced by additional first and second articular surface components for use in additional simulated surgical procedures. In yet another embodiment of the second aspect, the first and second articular surface components are comprised of a solid composition and provide for a fixed representation of the simulated joint. In yet another embodiment of the second aspect, the first and second articular surface components are comprised of a two-part polymer filled composition and provide for a representation of cortical or cancellous bone of the simulated joint. Further, the first and second articular surface components are configured to support trial components or implants for a total knee arthroplasty.

In one embodiment of a third aspect of the present disclosure, a method of assessing a simulated surgical procedure of a simulated joint includes configuring a first articular surface to a first end of a first bone of the simulated joint, configuring a second articular surface to second end of a second bone of the simulated joint, performing the surgical procedure on the simulated joint, and assessing the surgical procedure to determine an outcome characteristic of the simulated joint. The first and second ends are coupled by at least one flexible band simulating a ligament of the simulated joint such that the first articular surface is proximate to the second articular surface.

In another embodiment of the third aspect of the present disclosure, the simulated surgical procedure step includes resecting a portion of either the first or second articular surfaces. Additionally, performing the simulated surgical procedure step further includes not resecting a portion of either the first or second ends. In yet another embodiment of the third aspect, the outcome characteristic is stability or alignment of the simulated joint. In yet another embodiment of the third aspect, configuring the first and second articular surface steps are performed in a manual, navigated, robotic or virtual reality setting. In yet another embodiment of the third aspect, assessing the surgical procedure step includes comparing a first outcome characteristic for a first surgical procedure to a second outcome characteristic for a second surgical procedure. In yet another embodiment of the third aspect, the method further includes the step of registering the simulated joint using a plurality of checkpoint positions prior to the step of performing the surgical procedure on the simulated joint. In yet another embodiment of the third aspect, the outcome characteristic is determined by sensors, haptic arms, arrays, or trackers.

### BRIEF DESCRIPTION OF THE DRAWINGS

FIG. 1 is a front planar view of a joint simulator according to an aspect of the present disclosure.

FIG. 2 is rear planar view of the joint simulator of FIG. 1.

FIGS. 3A-3B are front planar view of first and second articular surface components of the joint simulator of FIG. 1.

FIGS. 4A-4B are perspective views of the first articular surface component and the joint simulator of FIG. 1.

FIGS. 5A-5B are perspective views of the second articular surface component and the joint simulator of FIG. 1.

FIG. 6 is a front planar view of a joint simulator according to another aspect of the present disclosure.

FIG. 7 is a perspective view of a plurality of articular surface components of the joint simulator of FIG. 1.

FIG. 8 is a flowchart representing a method related to the joint simulator according to an aspect of the present disclosure.

### DETAILED DESCRIPTION

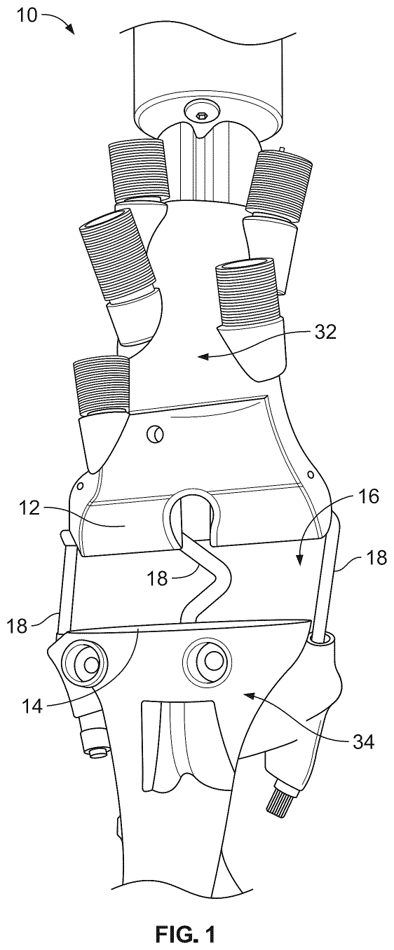

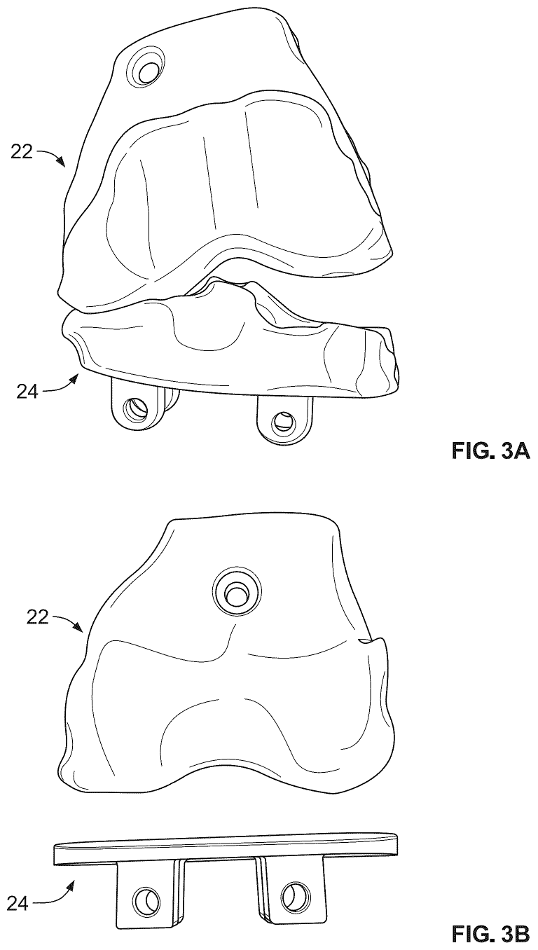

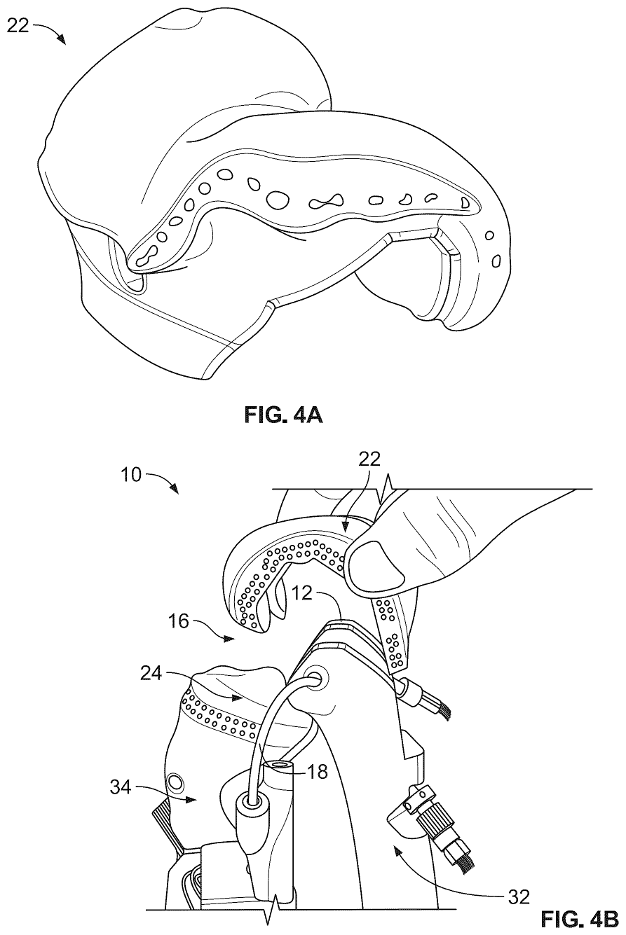

A joint simulator 10, shown in FIGS. 1-4B, is for simulating biomechanical properties of a human bone joint. Joint simulator 10 includes a first artificial bone 32 and a second artificial bone 34, respectively having a first anatomical head or a first end 12 and a second anatomical head or a second end 14. A first articular surface component 22 and a second articular surface 24 are disposed on first end 12 and second end 14, respectively. First and second articular surface components 22, 24 are designed to represent anatomical bone model simulations created by joint simulator 10. First and second articular surface components 22, 24 represent joint counter articular surfaces and a variety of particular anatomical/deformity scenarios found in practice. In this regard, first and second articular surface components 22, 24 may be constructed from one or more medical images, such as an MRI, so as to reproduce a particular articular surface scenario. Thus, first and second articular surface components 22, 24 may be constructed to represent various scenarios found in practice for teaching purposes or may be constructed to represent a specific patient as part of a surgeon's preoperative plan, for example. This allows a clinician to perform a simulated surgical procedure on first and second articular surface components 22, 24 using standard instrumentation to help determine depth of resections and resection orientations in order to achieve the desired joint line.

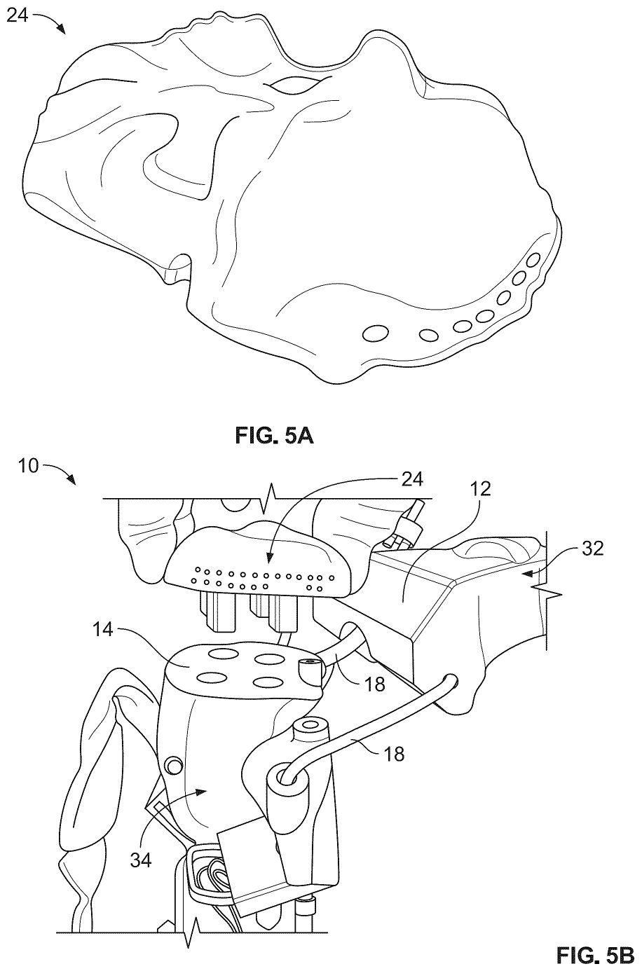

Joint simulator 10 shown in FIGS. 1-7 is used in simulating surgical procedures in human knee joints. First bone 32 and second bone 34 are an artificial femur and tibia, respectively. Therefore, first and second articular surface components 22, 24 represent articular surface components of a femur and tibia, respectively, for simulating a knee joint. However, in other arrangements, joint simulator 10 includes artificial bones and ligaments simulating any one or any combination of bones or ligaments naturally occurring in any human or animal bone joint. For example, joint simulator 10 may be constructed to include artificial bones and ligaments simulating all or any subset of the bones and ligaments of a knee joint, hip joint, elbow joint, shoulder joint, or any other human or animal anatomical joint. In further examples, simulated knee joints according to other arrangements include additional artificial bones such as a fibula, a patella, or both. To enhance the realism of joint simulator 10, first and second articular surface components 22, 24 can be fabricated using materials that closely mimic the natural cartilage and/or subchondral bone. This choice of materials provides the simulator with tactile feedback akin to that experienced during an actual surgical procedure, thereby aiding the surgeon in refining his or her tactile skills. Moreover, the modular nature of the articular surface components allows for the exchange of various surface topologies and deformities, enabling repetitive practice or the study of a wide range of pathological conditions without needing multiple complete simulators.

First and second ends 12, 14 of joint simulator 10 are proximate to one another and are separated by a gap or opening 16, as best shown in FIG. 1, when first and second surface components 22, 24 are not connected to first and second ends 12, 14. First and second artificial bones 32, 34 are held together to simulate the joint by at least one artificial ligament, tendon or band 18 as shown and described in U.S. patent application Ser. No. 17/189,850, the entire disclosure of which is incorporated by reference herein. Materials for the artificial ligaments may be chosen for their consistency, such that multiple simulations of the same joint will generally exhibit the same characteristics, or for their similarity to natural ligaments, among other characteristics. An exemplary suitable material for artificial ligament 18 is multi-strand nylon parachute cord. Such parachute cord is available in a number of diameters and bundle configurations. A parachute cord diameter and bundle arrangement may be selected on a case-by-case basis, for example by estimating the properties of the tendon to be simulated according to the individual patient (including consideration of factors such as age, lifestyle, disease, and physical condition) and the joint, assessing the condition of the tendon from data gathered from the patient, or both. A variety of polymers are also suitable for the artificial ligament 18. The polymer cords may be unitary or, like the parachute cord, formed in bundles of a number and diameter appropriate for the particular ligament to be simulated. Alongside the selection of materials like multi-strand nylon parachute cord for constructing artificial ligaments, biomimetic materials that closely replicate the viscoelastic properties of natural ligaments can also be considered. These materials can be engineered to match the tensile strength, elongation, and response to cyclic loading of a human ligament, thus providing a more accurate simulation of the physiological behavior during joint movement and stress. This becomes particularly useful for simulating complex, dynamic activities that stress the joint such as walking, running, or pivoting motions that are common in sports-related contexts.

First and second surface components 22, 24 represent articular or joint counter surface components when connected and used with joint simulator 10. First and second surface components 22, 24 are modular and provide for numerous combinations of procedural decisions when used with joint simulator 10. For example, procedural decisions include desired resection lines and trajectory and desired implant placement within or between first and second surface components 22, 24. These procedural decisions and their accompanying results are isolated to first and second surface components 22, 24, and do not modify or alter the construction of the other components of joint simulator 10. As discussed further below, first and second surface components 22, 24 may be single use or may be reused with joint simulator 10 in subsequent procedures. For example, in subsequent procedures, first and second surface components 22, 24 may be replaced with new and unused first and second surface components 22, 24 onto joint simulator 10. The modular aspect of the first and second surface components 22, 24 decreases material waste and expense when compared to other models such as saw bones. By replacing only the specific components that have undergone alteration during a simulated procedure, the overall system remains intact, extending the life of joint simulator 10 and reducing the need for complete replacement. Additionally, the ease of swapping out the surface components encourages repetitive practice and proficiency in various surgical scenarios, ultimately leading to enhanced surgical skill and confidence. First and second surface components 22, 24 may be patient specific based upon information recited from the patient, as described above. Alternatively, first and second surface components 22, 24 may be pre-prepared or pre-manufactured to represent generic articular surface components.

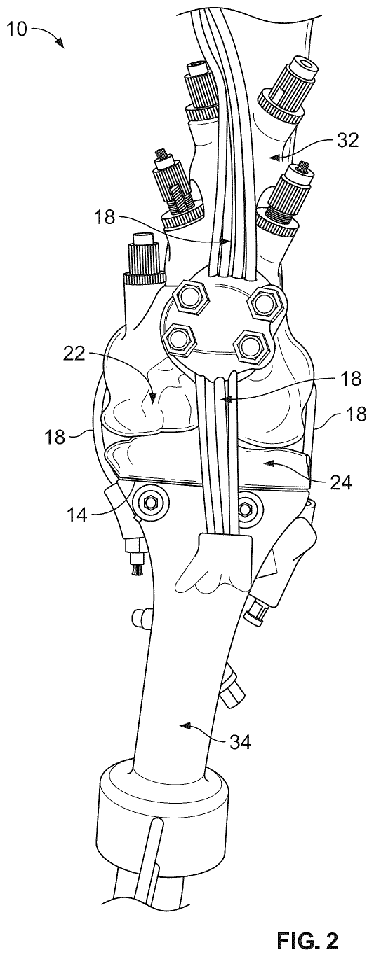

As best shown in FIGS. 2-5B, first and second surface components 22, 24 may be comprised of a solid composition and provide for a fixed representation of a bone anatomy. The solid compositions of first and second surface components 22, 24 may represent native diseased anatomy counter surface components for testing the effects of bone and cartilage loss on stability and alignment. Further, first and second surface components 22, 24 allow for the appreciation of the contribution of osteophytes to relative correct joint ability. For example, first and second surface components 22, 24 can be crafted to include protuberances and irregularities that replicate the presence of osteophytes, which are bone spurs commonly found at the margins of joints affected by osteoarthritic changes. These osteophyte models can be anatomically placed based on common patterns observed in patients with joint degeneration, providing a realistic challenge for their identification, evaluation, and potential removal during simulated surgery. The inclusion of osteophytes in the solid composition of the surface components allows for the study of their biomechanical impact on joint mechanics. For instance, clinicians can simulate and assess how osteophytes may impinge on soft tissue or affect the range of motion and congruency of the joint. These factors allow for improved surgical techniques to remove osteophytes with precision, minimizing collateral tissue damage and improving postoperative joint mobility. Further, the impact of osteophytes on joint loading and stress distribution can be explored through the use of joint simulator 10. This exploration may include determining whether the resection of these bony growths will likely result in significant alterations in weight-bearing and joint stabilization, which are critical considerations in joint preservation and reconstruction surgeries.

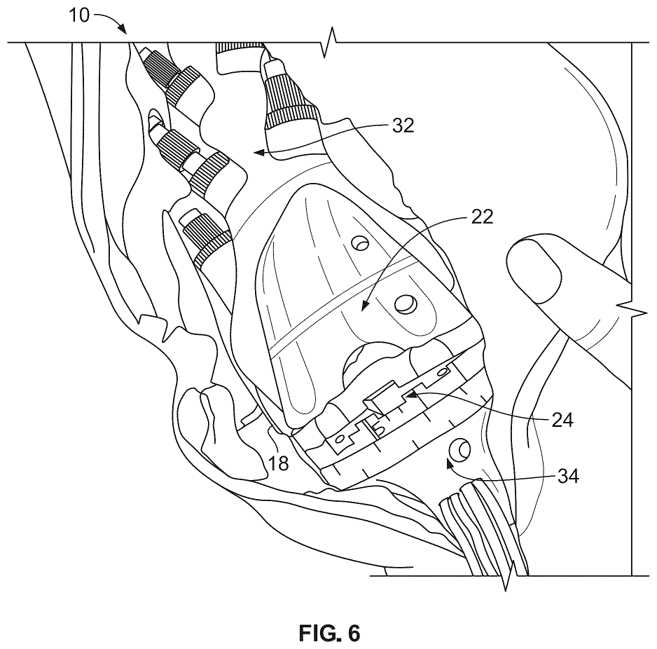

As best shown in FIG. 6, first and second surface components 22, 24 may be comprised of a two-part polymer filled composition and provide for a representation of cortical or cancellous bone. The modular aspect of first and second surface components 22, 24 allow a clinician or student to experiment with different techniques or approaches for the same anatomical scenario. As indicated above, this may be achieved by utilizing medical images of a candidate patient who expresses the desired soft tissue anatomy for teaching/experimental purposes or a specific patient about to undergo surgery for preoperative planning purposes.

In addition to the physical attributes, joint simulator 10 can be integrated with electronic sensors and software to deliver quantitative feedback to the user. Such sensors can measure forces, torques, and pressure distribution during the simulated surgical procedures. The system software is capable of recording this data and generating reports that analyze the user's technique and suggest improvements or confirm the attainment of competencies. The feedback loop created by this analytical component can significantly enhance the educational utility of joint simulator 10.

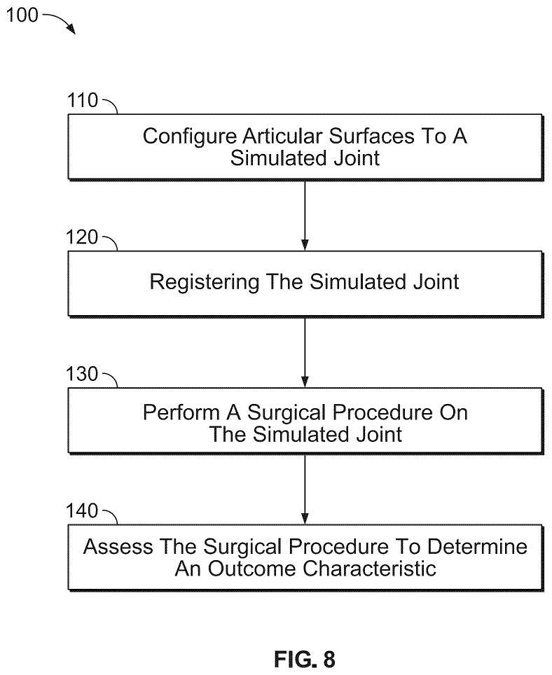

A method 100 of assessing a simulated surgical procedure of a simulated joint using joint simulator 10 is illustrated in FIG. 8. In step 110 of the method 100, joint simulator 10 is prepared by configuring first articular surface component 22 to the first end 12 of first bone 32, and second articular surface component 24 is configured to second end 14 of second bone 34. In step 110, first and second articular surface components 22, 24 may be configured to the respective first end and second ends 12, 14 in a manual, navigated, robotic or virtual reality setting. First and second articular surface components 22, 24 subsequently may be used and replaced by additional articular surface components during the method 100 and prior to or subsequent to the surgical procedure, as discussed further below.

In step 120 of the method 100, the simulated joint is registered using a plurality of checkpoint positions to generate a computer graphical model of the assembled simulated joint. The checkpoint positions may be used to quickly confirm the placement of the simulated joint into a desired anatomical scenario and reduce the need to register the simulated joint between each simulated surgical procedure. Step 120 is performed prior to performing the surgical procedure on the simulated joint in step 130, as discussed below. However, while performing the method 100, step 120 need not be performed and a student or clinician may proceed directly from step 110 to step 130.

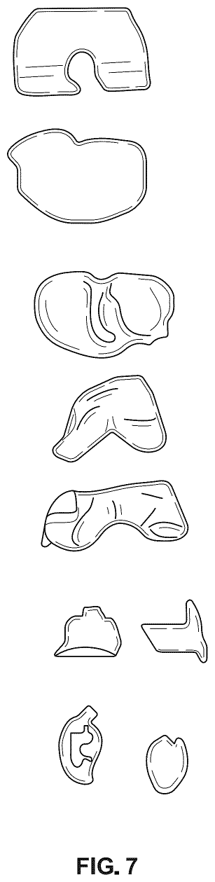

In step 130 of the method, the surgical procedure is performed on the simulated joint. Step 130 may include resecting a portion of either the first or second articular surface 22, 24 for assessing the surgical procedure. A plurality of resected and used articular surfaces are best shown in FIG. 7. However, step 130 may include not resecting a portion of either the first or second articular surface components 22, 24 for assessing the surgical procedure. The surgical procedure may comprise a total knee arthroplasty or varus knee deformity, as discussed further below.

In step 140 of the method 100, the surgical procedure performed in step 130 is assessed to determine an outcome characteristic of the simulated joint. The outcome characteristic may be stability or alignment of the simulated joint, and the outcome characteristic may be determined by sensors, haptic arms, arrays or trackers. Additionally, step 140 may include comparing a first outcome characteristic for a first surgical procedure to a second outcome characteristic for a second surgical procedure.

Method 100 provides a benefit of allowing a student or clinician to perform and experiment with different techniques or approaches for the same anatomical scenario. A variety of surgical procedures may be performed and assessed for a simulated joint in a certain anatomical scenario by simply using and replacing the articular surfaces from the simulated joint after each surgical procedure. For example, in a total knee arthroplasty procedure, a student or clinician may have decided between a 10 mm to 8 mm distal cut to an articular surface. By using joint simulator 10, the student or clinician may simulate both cuts in the same anatomical scenario by performing a first cut on a first articular surface of the simulated joint and assessing the results. The student or clinician can then replace the articular surfaces with new articular surfaces, and perform the second cut on the new articular surfaces to assess these new results. The student or clinician can then compare the results from the first and second cuts to the respective articular surfaces to determine which simulated surgical procedure would be more desirable in this specific anatomical scenario for the simulated joint. Similarly, complex varus knee deformities can be evaluated by a student or clinician by using joint simulator 10 in method 100. The articular surface of joint simulator 10 may be modified to simulate bone and cartilage loss, remodeling of subchondral bone, osteophyte formation and restriction of soft tissues. The student or clinician may perform the steps from method 100 to simulate procedures on the diseased or deformed anatomical scenario.

Further, method 100 allows for the understanding of the biomechanical consequences of each surgical intervention. By allowing repeated procedures on varied articular surface configurations, students and clinicians can visually and tactically analyze the impact of different resection depths, angular corrections, or implant placements on joint alignment, stability, and range of motion. This iterative learning process is desirable in determining the optimal surgical plan tailored to individual patient anatomy and pathology. In addition to the hands-on learning experience, method 100 can incorporate computer-generated predictive modeling that provides a statistical analysis of likely outcomes based on the simulated surgeries. This predictive modeling can be derived from a compilation of previous surgical data and outcomes, thereby offering evidence-based guidance on which surgical options might yield the best patient outcomes. Consequently, students and clinicians can refine their decision-making process through a combination of empirical evidence and practical application.

It should also be noted that method 100 allows for minimally invasive options by simulating smaller incisions or percutaneous techniques and allows for the assessment of their potential benefits and challenges. Given the increasing interest in less invasive surgical options, such practice could prove beneficial for surgical training. Additionally, integration with VR/AR systems can augment this experience by enabling visualization of underlying structures during simulated minimally invasive procedures, offering an insight into navigating complex surgeries with limited direct visibility.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A joint simulator for simulating biomechanical properties of a joint, comprising:
a first end simulating a first bone of the joint;
a second end simulating a second bone of the joint;
at least one flexible band simulating a ligament of the joint, the flexible band coupling the first and second ends, wherein the flexible band is adjustable to simulate stresses corresponding to the first and second ends; and
a first and second surface component, the first surface component being connected to the first end, and the second surface component is connected to the second end, wherein the first surface component simulates a distal end of the first bone and the second surface component simulates a proximal end of the second bone.

2. The joint simulator of claim 1, wherein the first and second ends are separated by an opening of the joint simulator.

3. The joint simulator of claim 2, wherein the first end is proximate to the second end.

4. The joint simulator of claim 1, wherein the first and second surface components are comprised of a solid composition and provide for a fixed representation of a bone anatomy.

5. The joint simulator of claim 1, wherein the first and second surface components are comprised of a two-part polymer filled composition and provide for a representation of cortical or cancellous bone.

6. The joint simulator of claim 1, wherein the first and second surface components are patient specific.

7. The joint simulator of claim 1, wherein the first and second surface components are for a single use and are disposable.

8. The joint simulator of claim 1, wherein the first bone is a femur and the second bone is a tibia.

9. The joint simulator of claim 8, wherein the first surface component is a tibia counter surface assembly, and the second surface component is a femoral counter surface assembly.

10. The joint simulator of claim 1, wherein the first and second surface components are native diseased anatomy counter surfaces.

11. A simulated joint, comprising:
a first articular surface component connected to a first end simulating a first bone of the simulated joint;
a second articular surface component connected to a second simulating a second bone of the simulated joint, wherein portions of the first and second articular surface components are configured to be resected during a simulated surgical procedure; and
at least one flexible band simulating a ligament of the simulated joint, the flexible band coupling the first and second ends such that the first articular surface is proximate to the second articular surface.

12. The simulated joint of claim 11, wherein the first articular surface component is a tibia counter surface assembly, and the second articular surface component is a femoral counter surface assembly.

13. The simulated joint of claim 12, wherein the simulated surgical procedure is a total knee arthroplasty.

14. The simulated joint of claim 11, wherein the first and second articular surface components are configured to be removed after the simulated surgical procedure.

15. The simulated joint of claim 14, wherein the first and second articular surface components are configured to be replaced by additional first and second articular surface components for use in additional simulated surgical procedures.

16. The simulated joint of claim 11, wherein the first and second articular surface components are comprised of a solid composition and provide for a fixed representation of the simulated joint.

17. The simulated joint of claim 11, wherein the first and second articular surface components are comprised of a two-part polymer filled composition and provide for a representation of cortical or cancellous bone of the simulated joint.

18. The simulated joint of claim 17, wherein the first and second articular surface components are configured to support trial components or implants for a total knee arthroplasty.

19. A method of assessing a simulated surgical procedure of a simulated joint, comprising:
configuring a first articular surface to a first end of a first bone of the simulated joint;
configuring a second articular surface to second end of a second bone of the simulated joint, wherein the first and second ends are coupled by at least one flexible band simulating a ligament of the simulated joint such that the first articular surface is proximate to the second articular surface;
performing the surgical procedure on the simulated joint; and
assessing the surgical procedure to determine an outcome characteristic of the simulated joint.

20. The method of claim 19, wherein the step of performing the surgical procedure includes resecting a portion of either the first or second articular surfaces.
